(19) United States
(12) Patent Application Publication
(10) Pub. No.: US 2025/0001333 A1
(43) Pub. Date: Jan. 2, 2025

(54) FILTER, FILTER COMPONENT, AND FILTER CONNECTOR SYSTEM HAVING INTERLOCKING TABS AND RETENTION ELEMENTS

(71) Applicant: Caterpillar Inc., Peoria, IL (US)

(72) Inventors: Brian J. Sutton, Edwards, IL (US); Iulian G. Ghiorghias, Dunlap, IL (US); Kevin L. Dea, Morton, IL (US); Zack Heydenrych, Kalamazoo, MI (US); Jonas Eble, Erlenbach (DE); Martin Sonntag, Freiberg a.N. (DE)

(73) Assignee: Caterpillar Inc., Peoria, IL (US)

(21) Appl. No.: 18/217,070

(22) Filed: Jun. 30, 2023

(51) Int. Cl. B01D 29/96; B01D 29/15

(52) U.S. Cl. CPC B01D 29/96; B01D 29/15; B01D 2201/347; B01D 2201/4076

(57) ABSTRACT

A filter component for a fluid system includes a connector having a peripheral surface including a plurality of retention elements each including a first tab stop surface, an end surface, and a rostrate overhang including a second tab stop surface. A plurality of tab channels are defined between adjacent ones of the retention elements and each include a tapered lead-in section, a middle section, and a securement section extending in a circumferential direction from the middle section to the first tab stop surface.

### TECHNICAL FIELD

The present disclosure relates generally to a fluid system employing filtration, and more particularly to a connector system for releasably attaching a filter element to a filter housing.

### BACKGROUND

All manner of mechanical systems are known throughout the world employing filters for various purposes. Most, if not all, internal combustion engines employ filters for filtration of liquids including engine oil, fuel, coolant, and others. A wide variety of filter types and overall filtration systems have been used for well over a century.

As particles are collected in a filter medium the efficacy of the filter can degrade over time, potentially leading to an undesired pressure drop through the filter, fluid leaks, or other problems. It is generally conventional practice to change out filters on a regular surface interval or when diagnostic equipment indicates filter change is needed.

Filter disassembly, removal, and reinstallation is desirably simple and straightforward. For various reasons, filter swapping when an engine or other machinery is serviced can be more time consuming and labor intensive than theoretically required. Moreover, in some instances attaching and/or un-attaching filter components to one another can result in spilled fluids and/or introduction of contamination into the fluid system.

Filters and related filter components intended to be serviceable often employ some type of mechanism for securely and releasably locking or positioning a filter element in place. A threaded interface is commonly used. Various other connectors and connector strategies including bayonet connectors, tab and slot connectors, and still others are also well known and in widespread use. One example of a replaceable filter configuration in a liquid filter application is known from U.S. Pat. No. 6,814,243 B2 to Amstutz et al. The art provides ample opportunity for improvements and development of alternative strategies.

### SUMMARY

In one aspect, a filter component includes a peripheral surface including a plurality of retention elements having a circumferential distribution around an axis. The plurality of retention elements each include a first tab stop surface facing a first circumferential direction, an end service facing a first axial direction, and a rostrate overhang extending in a first circumferential direction from the first tab stop surface and including a second tab stop surface facing a second axial direction. The filter component further includes a plurality of tab channels each defined between adjacent ones of the plurality of retention elements and including a tapered lead-in section opening in the first axial direction, a middle section, and a securement section extending in a second circumferential direction from the middle section to the first tab stop surface of one of the two adjacent ones of the plurality of retention elements.

In another aspect, a connector system for a filter assembly includes a first peripheral surface having a plurality of tabs, and a second peripheral surface including a plurality of retention elements. The first peripheral surface and the second peripheral surface are positionable in co-axial alignment around an axis to position the plurality of tabs and the plurality of retention elements at respectively offset circumferential distributions around the axis. The plurality of retention elements each include a first tab stop surface facing a first circumferential direction, an end surface facing a first axial direction, and a rostrate overhang extending in a first circumferential direction from the first tab stop surface and including a second tab stop surface facing a second axial direction. The connector system further includes a plurality of tab channels each including a tapered lead-in section defined between the end surfaces of two adjacent ones of the plurality of retention elements and opening in the first axial direction, a middle section, and a securement section extending in a second circumferential direction from the middle second to the first tab stop surface of one of the two adjacent ones of the plurality of retention elements.

In still another aspect, a filter element includes a filter medium extending around an axis, and a connector for mounting the filter medium in a filter housing, the connector including an outer peripheral surface and projecting in an axial direction from the filter medium. The connector further includes a plurality of retention elements upon the outer peripheral surface and having a circumferential distribution around the axis. The connector further includes a plurality of tab channels each defined between two adjacent ones of the plurality of retention elements, and each including a tapered lead-in section opening in the axial direction, a middle section, and a securement section extending in a circumferential direction from the middle section.

### BRIEF DESCRIPTION OF DRAWINGS

FIG. 1 is a sectioned diagrammatic view of a fluid system, according to one embodiment;

FIG. 2 is a diagrammatic view of filter assemblies suitable for use in the fluid system of FIG. 1;

FIG. 3 is another diagrammatic view of filter assemblies as in FIG. 2;

FIG. 4 is a diagrammatic view of filter elements suitable for use in the fluid system of FIG. 1;

FIG. 5 is a diagrammatic view of a filter housing, according to one embodiment;

FIG. 6 is a sectioned side diagrammatic view of a portion of a filter housing, according to one embodiment;

FIG. 7 is a diagrammatic view of a portion of the filter housing of FIG. 6;

FIG. 8 is a diagrammatic view of a portion of a filter element, according to one embodiment;

FIG. 9 is an end view of the filter element as in FIG. 8;

FIG. 10 is a diagrammatic view depicting installation of a filter element in a filter housing, according to one embodiment; and

FIG. 11 is a diagrammatic view showing a filter element installed in a filter housing, according to one embodiment.

### DETAILED DESCRIPTION

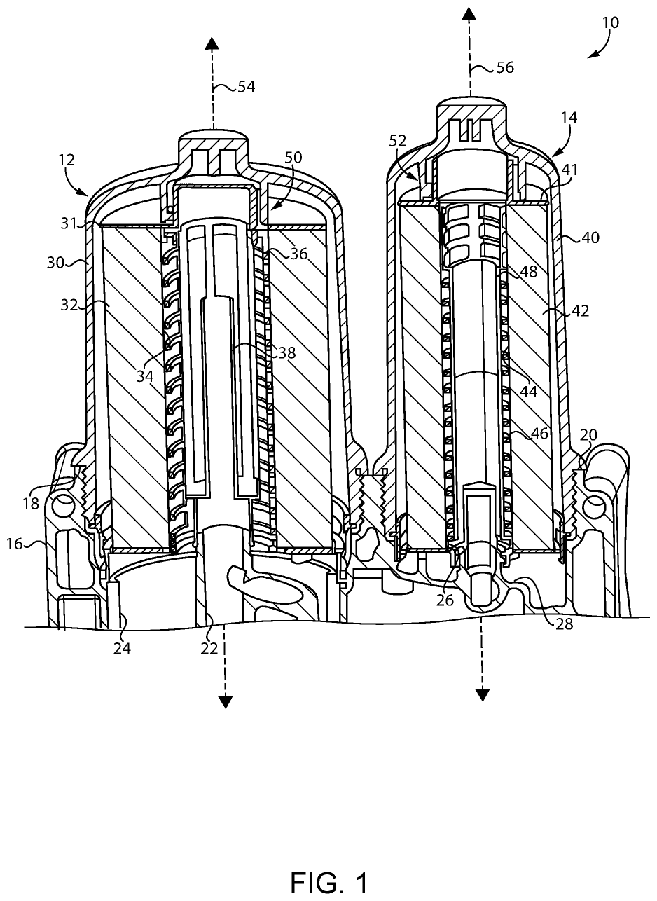

Referring to FIG. 1, there is shown a fluid system 10, according to one embodiment. Fluid system 10 may include a fuel system for an internal combustion engine. The present disclosure is not thereby limited, however, and other fluid systems employing fluids such as oil, engine coolant, hydraulic fluid, water, or still others are within the scope of the present disclosure. In an embodiment, fluid system 10 includes a first filter assembly 12 and a second filter assembly 14. First filter assembly 12 and second filter assembly 14 may be arranged in series to filter fuel, for example a hydrocarbon distillate such as diesel, in a primary filtration stage using first filter assembly 12, and a secondary filtration stage using second filter assembly 14. In other instances, only a single filter assembly and single filtration stage might be used in a fluid system. Fluid system 10 also includes a system housing 16 having a first threaded filter socket 18 receiving first filter assembly 12 and a second threaded filter socket 20 receiving second filter assembly 14. First filter assembly 12 may include an inlet tube 22 carrying fluid to be filtered, and a fluid collection cavity or bowl 24. Second filter assembly 14 may include an inlet tube 26 and a collection cavity or bowl 28.

First filter assembly 12 includes a first filter housing 30. A first filter element 31 is received in first filter housing 30 and includes a first filter medium 32 extending circumferentially around a flow passage 34. First filter element 31 may also include a scaffold 36 and a tube assembly 38 each positioned at least partially within flow passage 34. Second filter assembly 14 includes a second filter housing 40 having a second filter element 41 received therein and including a second filter medium 22 extending circumferentially around a flow passage 44. A scaffold 46 and a tube assembly 48 may be positioned at least partially within filter medium 42. In the illustrated embodiment, fluid to be filtered may flow upwardly through each respective filter assembly and thenceforth downward and inward at least in part under the force of gravity and through the respective filter medium.

It should be appreciated that the present disclosure is not limited with regard to the direction or manner of flow of fluid through or between filter assemblies, nor limited with regard to internal structures of a filter element or lack thereof. In the illustrated embodiment first filter assembly 12 and second filter assembly 14 are vertically oriented and supported vertically above system housing 16. It has been discovered that during servicing fluid system 10 to replace one or both of filter elements 31 or 41 that it can be desirable to maintain attachment temporarily between the respective filter elements and filter housings when filter assemblies 12 and 14 are disengaged from system housing 16.

To this end, filter assembly 12 includes a connector system 50 and filter assembly 14 includes a connector system 52. First filter assembly 12 can be disengaged from system housing 16 by rotating first filter housing 30 about an axis 56 to disengage a threaded connection of filter housing 30 with filter socket 18. Second filter assembly 14 can be removed analogously by rotating about an axis 56. A user can then lift off the filter assemblies with the filter elements still attached, swap a used filter element with a new filter element, and then reinstall the filter assemblies in fluid system 10. As will be further apparent from the following description connector system 50 and connector system 52, and other analogous connector systems contemplated herein, are uniquely configured to quickly and easily engage or disengage to enable swapping out of filter elements.

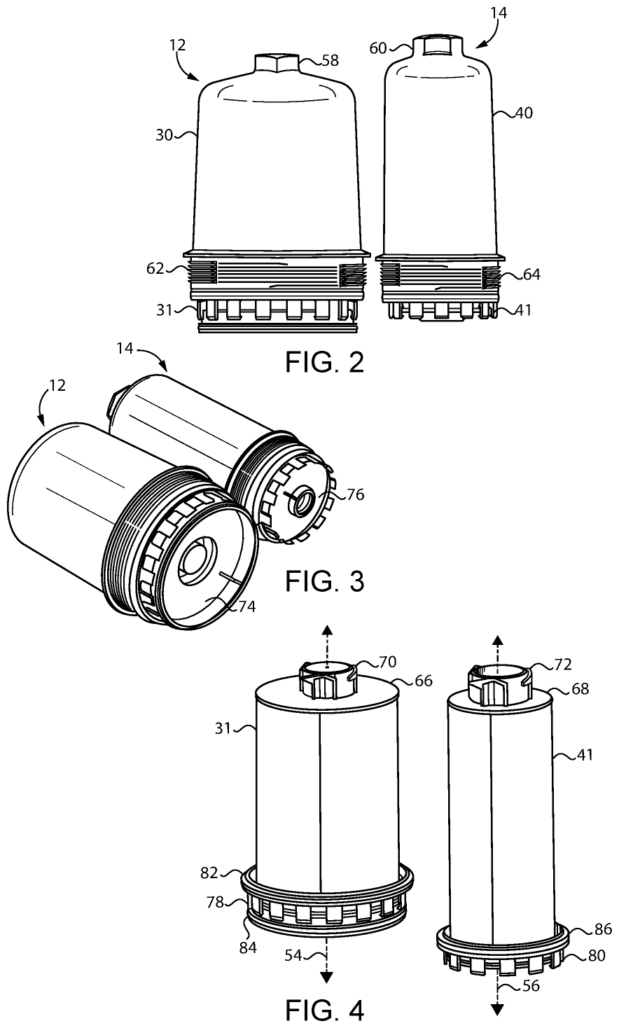

Referring also now generally to FIGS. 2, 3, and 4, there are shown additional features and details of filter assemblies 12 and 14. Focusing on FIG. 2, first filter assembly 12 and first filter housing 30 may include an end protrusion 58 extending in an axial direction. End protrusion 58 provides a handhold or a tool hold, and may be equipped with tool engagement surfaces in a hexagonal form, for example, such that a user can rotate first filter assembly 12 to disengage threads 62 from system housing 16 as suggested above. Second filter assembly 14 may likewise include an end protrusion 60 which may be analogously configured to enable a user to disengage or engage threads 64 on second filter housing 40 with system housing 16. In the illustrated embodiment threads 62 and threads 64 include external threads. It can also be seen from FIG. 2 that filter element 31 and filter element 41 extend somewhat outside of the respective filter housings 30 and 40 when installed. FIG. 3 illustrates an alternative view of filter assemblies 12 and 14.

Focusing on FIG. 4, first filter element 31 may include an end plate 66 and second filter element 41 may include an end plate 68. End plates 66 and 68 may be attached to the respective filter medium. Filter element 31 may further include a connector protrusion 70 attached to end plate 66 and projecting in an axial direction, and filter element 41 may include a connector protrusion 70 attached to end plate 68 and projecting in an axial direction. Filter element 31 may further include an opposite end plate 74 and filter element 41 may include an opposite end plate 76 each attached to the respective filter medium. Filter element 31 may further include a rotatable bracket 78 coupled to opposite end plate 74, and filter element 41 may include a rotatable bracket 80 coupled to opposite end plate 76. Each bracket 78 and 80 may be rotatable relative to the respective opposite end plate 74 and 76. Each bracket 78 and 80 may also be movable in an axial direction relative to the respective opposite end plate 74 and 76. Filter element 31 may include a first seal 82 mounted upon bracket 78 and a second seal 84 axially spaced from seal 82 and also mounted upon bracket 78. Filter element 41 may include a seal 86 mounted upon bracket 80. Each of seals 78, 82, and 84, may include a non-metallic gasket, one or more O-rings, or still another seal type. When installed for service in the respective filter assemblies in system housing 16 seals 82, 84, 86 can provide suitable fluid seals for sealing the fluid within the fluid system 10 as well as potentially providing for appropriate fluid connections for routing fluid flow. The rotatable and axially movable features of brackets 78 and 80 can enable filter housings 30 and 40 to be rotated to disengage threaded connections with system housing 16 while fluid sealing is maintained.

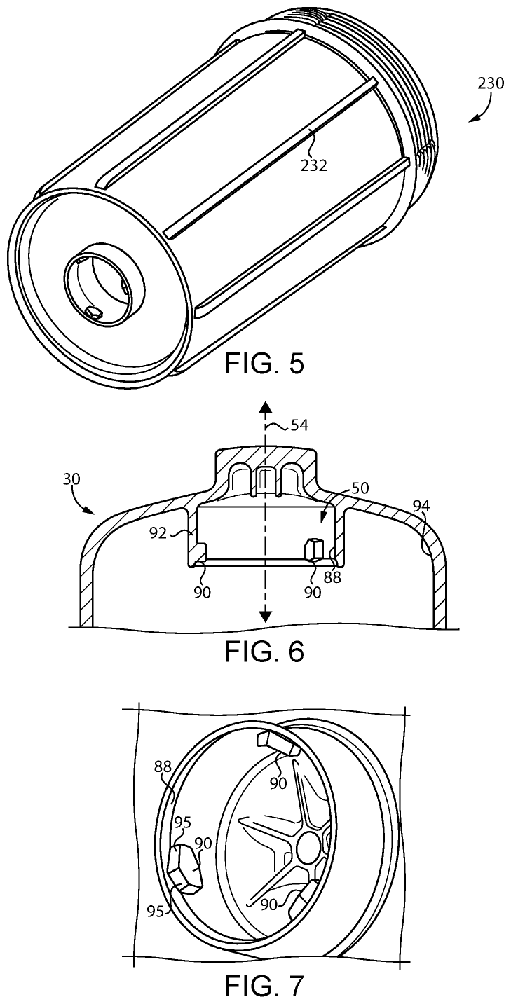

FIG. 5 shows an alternative embodiment of a filter housing 230 having similarities with filter housings 30 and 40 discussed above, but a different configuration including external ribs or flutes 232.

Focusing now on FIGS. 6 and 7, there are shown additional features of filter housing 30. It should be appreciated that filter housings according to the present disclosure may have a range of sizes, shapes, and applications. Moreover, it should also be appreciated that connector systems for filter components may generally be analogously configured across different housing sizes, shapes, and service applications. Accordingly, description and discussion herein of any one embodiment should be understood by way of analogy to refer to any other embodiment expect where otherwise indicated or apparent from the context. It will be recalled that a filter component, including a filter housing or a filter element, can include part of a connector system. It is contemplated that connector system 50, or other connector systems contemplated herein, can include parts upon a filter housing and also parts upon a filter element. It should also be appreciated that embodiments are contemplated where the arrangement of which parts are on a filter element and which parts are on a filter component might be the reverse of that shown and described herein.

Filter housing 30 includes a first peripheral surface 88 extending circumferentially around axis 54 and including a plurality of protruding tabs 90. In the illustrated embodiment a wall 92 includes first peripheral surface 88 and extends downwardly into a cavity 94 which receives the corresponding filter element. Tabs 90 will typically include at least three tabs having a circumferential distribution around axis 54. In other embodiments, more than three tabs might be used, or potentially fewer. Each tab 90 may include a plurality of angled surfaces 95 facilitating engagement with receiving structure on a filter element as further discussed herein. In the illustrated embodiment first peripheral surface 88 is an inner peripheral surface with tabs 90 projecting radially inward. In an alternative embodiment first peripheral surface 88 could include an outer peripheral surface with tabs 90 projecting radially outward.

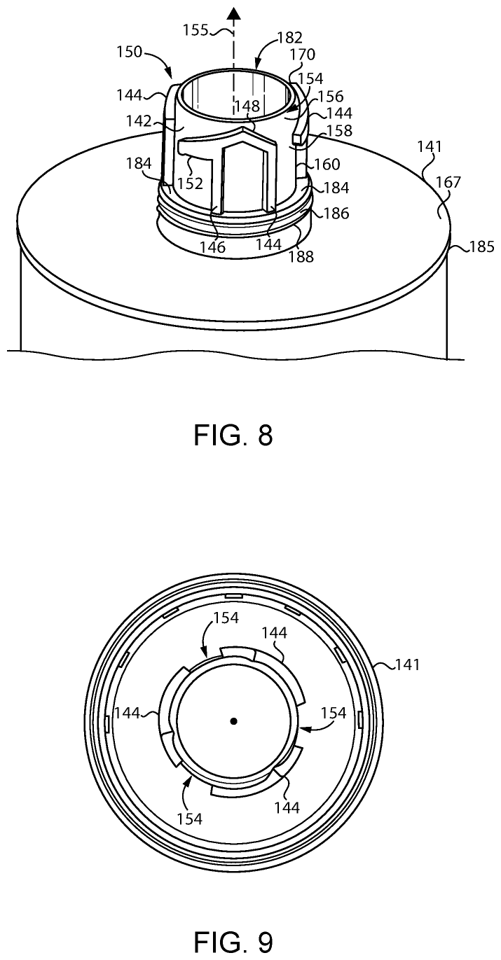

Referring also now to FIGS. 8 and 9, there is shown a filter element 141 having similarities to previously described embodiments, and suitable for coupling with filter housing 30. Filter element 141 includes a second peripheral surface 142 including a plurality of retention elements 144. In the illustrated embodiment second peripheral surface 142 is an outer peripheral surface with retention elements 144 projecting radially outward. In an alternative configuration second peripheral surface 142 could be an inner peripheral surface with retention elements 144 projecting radially inward.

First peripheral surface 88 and second peripheral surface 142 may be positionable in coaxial alignment around an axis 54, 155 to position tabs 90 and retention elements 144 at respectively offset circumferential distributions around the axis 54, 155. It should be appreciated further that filter housings and filter elements as well as connector protrusions and/or features thereof may all be understood to define an axis as contemplated herein. When components in a filter assembly are assembled for service the several axes may all be colinear. Thus, references herein to any specific axis are intended in a non-limiting fashion.

Retention elements 144 may each include a first tab stop surface 146 facing a first circumferential direction, around axis 155, and an end surface 148 facing a first axial direction, an up direction in the FIG. 8 illustration. Each of retention elements 144 may further include a rostrate overhang 151 extending in the first circumferential direction from retention element 144 and from the first tab stop surface 146. Each rostrate overhang 151 includes a second tab stop surface 152 facing a second axial direction. First tab stop surface 146 and second tab stop surface 152 may be oriented normal to one another. A rostrate overhang as discussed herein has a beak or bill-like geometry, and overhangs a part of a tab channel as further discussed herein.

Filter component 141 may further include a plurality of tabs channels 154 each defined between two adjacent ones of the plurality of retention elements 144. Each tab channel 154 may include a tapered lead-in section opening in the first axial direction, a middle section 158, and a securement section 160 extending in a second circumferential direction from the respective middle section 158 to the first tab stop surface 146 of one of the two adjacent ones of the plurality of retention elements 144.

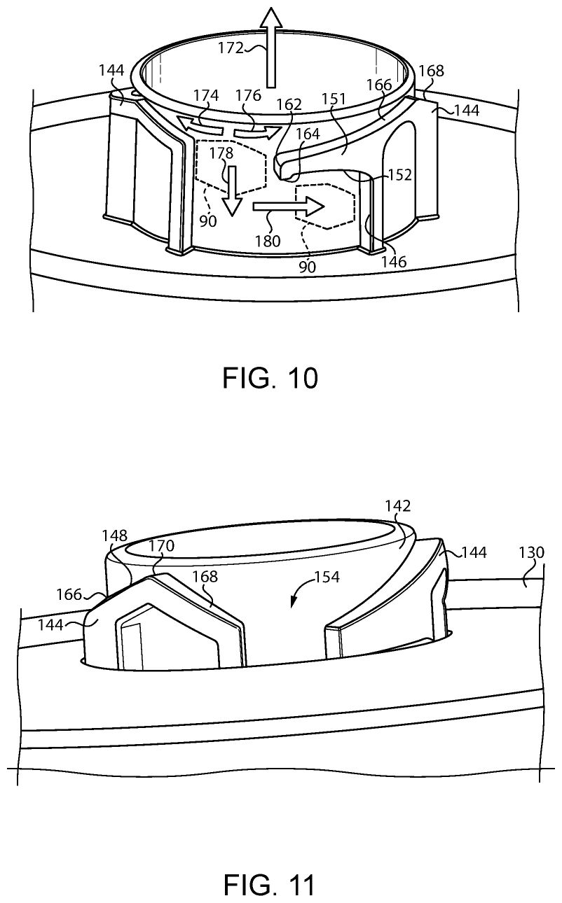

Also in the illustrated embodiment tapered lead-in section 156 is defined between the end surfaces 148 of each respective two adjacent ones of the plurality of retention elements 144. Referring also now to FIGS. 10 and 11, each end surface 148 may form a peak 170. Rostrate overhang 151 may include a forward sloped lead-in surface 166. Lead-in surface 166 forms in part a first adjacent one of lead-in sections 156. Each end surface 148 may further include a rearward sloped lead-in surface 168 forming in part a second adjacent one of lead-in sections 156. Put differently, forward sloped lead-in surface 166 and rearward sloped lead-in surface 168 define parts of two different tab channels 154.

Forward sloped lead-in surface 166 may advance from peak 170 in the first circumferential direction, approximately clockwise in FIG. 10, and in the second axial direction, approximately down in the illustrations of FIGS. 10 and 11. Rearward sloped lead-in surface 168 may advance from peak 170 in the second circumferential direction, approximately counterclockwise in FIG. 10, and in the second axial direction. The first circumferential direction and the second circumferential direction are opposite circumferential directions relative to one another. In FIG. 10 the first axial direction is shown approximately by way of arrow 172. The first circumferential direction is shown by way of arrow 174, and the second circumferential direction is shown via arrow 176. Arrow 178 generally denotes the second axial direction.

Returning focus to FIG. 8, it will be recalled peripheral surface 142 includes an outer peripheral surface upon a connector protrusion 182. Connector protrusion 182 is shown having an open center in the first axial direction. In other embodiments, a connector protrusion can be closed. It can also be noted connector protrusion 182 is spaced radially inward from an outer perimeter 185 of an end plate 167 of filer element 141. In other embodiments, tabs or retention elements in a connector system might not be located upon a protrusion at all but instead upon an outer perimetric surface of a filter element, or potentially an inner perimetric surface of a filter housing. In such embodiments, a connector as contemplated herein might not be a connector protrusion.

FIG. 8 also shows a plurality of base surfaces 184 of connector protrusion 182 extending between two adjacent ones of retention elements 144. Base surfaces 184 can be understood to face the first axial direction as described herein. A seal 186 may be mounted on connector protrusion 182 adjacent to base surfaces 184 and seated in a seal grove 188. Seal 186 may include an O-ring, a gasket, or another type of sealing element and fluidly seals with a filter housing.

### INDUSTRIAL APPLICABILITY

Still referring to the drawings generally, but returning focus to FIG. 10, a tab 90 is shown in phantom lines at two locations as it might appear being engaged in a tab channel 154 between two retention elements 144. It will be recalled that tabs and retention elements can be positioned at respectively offset circumferential locations. To remove a filter element from a filter housing as discussed herein, when the filter housing and the filter element are removed from a system housing a user can grasp the filter element and rotate the filter element and displace it axially relative to the filter housing to disengage the tabs and retention elements, and then remove the filter element from the filter housing. When installing a filter element in a filter housing the user will position the filter element into the cavity in the filter housing, and typically rotate the filter element relative to the filter housing to enable the tabs to settle into a tapered lead-in section of a tab channel formed between retention elements. Angled surfaces of each tab, as shown for example in FIG. 7, can cooperate with sloped surfaces of two adjacent retention elements to properly locate the tabs for entering the middle sections of each tab channel. With the tabs entering and passing axially through the middle sections of the tab channels, the filter element can be rotated relative to the filter housing to rotate tabs underneath rostrate overhangs and eventually butt up against one or both of the first tab stop surface and second tab stop surface as discussed herein. The rostrate overhangs 151 may themselves taper to a tip or nose 162 as labeled in FIG. 10. In the embodiment of FIG. 10 the rostrate overhangs 151 may each include a tab retention bump 164 upon second tab stop surface 152 adjacent to tip 162 that assists in preventing rotation and disengagement of the respective tab 90 once engaged.

As also noted above in some instances it can be desirable to maintain engagement between a filter element and a filter housing. A user can lift the filter housing with the attached filter element out of a system housing without dropping the used filter element or requiring both hands to hold both a filter housing and a filter element. As such the filter housing and attached filter element can be taken to a location where the two components separated thus avoiding leakage, mess, and easing the overall filter exchange process.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A filter component comprising:
a peripheral surface including a plurality of retention elements having a circumferential distribution around an axis;
the plurality of retention elements each including a first tab stop surface facing a first circumferential direction, an end surface facing a first axial direction, and a rostrate overhang extending in a first circumferential direction from the first tab stop surface and including a second tab stop surface facing a second axial direction; and
a plurality of tab channels each defined between two adjacent ones of the plurality of retention elements and including a tapered lead-in section opening in the first axial direction, a middle section, and a securement section extending in a second circumferential direction from the middle section to the first tab stop surface of one of the two adjacent ones of the plurality of retention elements.

2. The filter component of claim 1 further comprising a filter medium, an end plate attached to the filter medium, and a connector protrusion including the peripheral surface and projecting from the end plate.

3. The filter component of claim 2 further comprising an opposite end plate attached to the filter medium, a rotatable bracket coupled to the opposite end plate, and a seal mounted upon the rotatable bracket.

4. The filter component of claim 1 wherein the peripheral surface includes an outer peripheral surface.

5. The filter component of claim 1 wherein the tapered lead-in section is defined between the end surfaces of each respective two adjacent ones of the plurality of retention elements.

6. The filter component of claim 1 wherein the rostrate overhang is tapered to a tip in the first circumferential direction, and includes a tab retention bump upon the second tab stop surface.

7. The filter component of claim 1 wherein the rostrate overhang includes a forward sloped lead-in surface forming in part a first adjacent one of the lead-in sections, and the end surface includes a rearward sloped lead-in surface forming in part a second adjacent one of the lead-in sections.

8. The connector system of claim 7 wherein the end surface forms a peak, and the forward sloped lead-in surface advances in the first circumferential direction and the second axial direction from the peak, and the rearward sloped lead-in surface advances in the second circumferential direction and the second axial direction from the peak.

9. A connector system for a filter assembly comprising:
a first peripheral surface including a plurality of tabs;
a second peripheral surface including a plurality of retention elements;
the first peripheral surface and the second peripheral surface are positionable in coaxial alignment around an axis to position the plurality of tabs and the plurality of retention elements at respectively offset circumferential distributions around the axis;
the plurality of retention elements each including a first tab stop surface facing a first circumferential direction, an end surface facing a first axial direction, and a rostrate overhang extending in a first circumferential direction from the first tab stop surface and including a second tab stop surface facing a second axial direction; and
a plurality of tab channels each including a tapered lead-in section defined between the end surfaces of two adjacent ones of the plurality of retention elements and opening in the first axial direction, a middle section, and a securement section extending in a second circumferential direction from the middle section to the first tab stop surface of one of the two adjacent ones of the plurality of retention elements.

10. The connector system of claim 9 wherein the first peripheral surface includes an inner peripheral surface, and the second peripheral surface includes an outer peripheral surface.

11. The connector system of claim 10 further comprising:
a plurality of base surfaces each extending between two adjacent ones of the plurality of retention elements and facing the first axial direction;
a connector protrusion including the second peripheral surface; and
a seal mounted on the connector protrusion adjacent to the plurality of base surfaces.

12. The connector system of claim 9 wherein the rostrate overhang includes a forward sloped lead-in surface forming in part a first adjacent one of the lead-in sections, and a rearward sloped lead-in surface forming in part a second adjacent one of the lead-in sections.

13. The connector system of claim 12 wherein the end surface forms a peak, and the forward sloped lead-in surface advances in the first circumferential direction and the second axial direction from the peak, and the rearward sloped lead-in surface advances in the second circumferential direction and the second axial direction from the peak.

14. A filter element comprising:
a filter medium extending around an axis;
a connector for mounting the filter medium in a filter housing, the connector including an outer peripheral surface and projecting in an axial direction from the filter medium;
the connector further including a plurality of retention elements upon the outer peripheral surface and having a circumferential distribution around the axis; and
the connector further including a plurality of tab channels each defined between two adjacent ones of the plurality of retention elements, and each including a tapered lead-in section opening in the axial direction, a middle section, and a securement section extending in a circumferential direction from the middle section.

15. The filter element of claim 14 wherein each of the plurality of retention elements includes an overhang extending in an opposite circumferential direction and including a sloped surface defining in part one of the lead-in sections, and a tab stop surface facing an opposite axial direction and defining in part the respective one of the securement sections.

16. The filter element of claim 15 wherein each of the plurality of retention elements includes another tab stop surface facing the opposite circumferential direction.

17. The filter element of claim 16 wherein the tab stop surface and the another tab stop surface are oriented normal to one another.

18. The filter element of claim 15 wherein the overhang tapers to a tip defining in part a respective one of the middle sections.

19. The filter element of claim 14 further comprising an end plate attached to the filter medium, an opposite end plate attached to the filter medium, and the connector is located radially inward of an outer perimeter of the end plate.

20. The filter element of claim 19 further comprising a bracket coupled to the opposite end plate, and a seal mounted upon the bracket, and wherein the bracket is rotatable and axially movable relative to the filter medium.
